(19) United States
(12) Patent Application Publication
(10) Pub. No.: US 2014/0365185 A1
(43) Pub. Date: Dec. 11, 2014

(54) NUMERICAL CALCULATION METHOD AND APPARATUS

(71) Applicant: FUJITSU LIMITED, Kawasaki-shi (JP)

(72) Inventor: Masaki KAZAMA, Kawasaki (JP)

(73) Assignee: FUJITSU LIMITED, Kawasaki-shi (JP)

(21) Appl. No.: 14/256,164

(22) Filed: Apr. 18, 2014

(30) Foreign Application Priority Data
Jun. 11, 2013 (JP) 2013-122330

(51) Int. Cl. G06F 17/50

(52) U.S. Cl. CPC G06F 17/5009
USPC 703/2

(57) ABSTRACT

A method realizes numerical high-precision calculation of an interflow phenomenon of liquids having different reference densities. Specifically, the method includes: calculating a first and second physical quantities by using, in a Riemann invariant, a ratio of a first or second density of a first or second particle to a first or second reference density, instead of the first or second density; calculating a first time-space intermediate value for the first and second physical quantities between the first and second particles, by using the first and second physical quantities; calculating time-space intermediate values for pressure and velocity between the first and second particles, by using the first time-space intermediate value. Then, a velocity of the first particle updated by using the second time-space intermediate value for pressure, and the first density of the first particle is updated based on the time-space intermediate value for velocity.

### CROSS-REFERENCE TO RELATED APPLICATIONS

This application is based upon and claims the benefit of priority of the prior Japanese Patent Application No. 2013-122330, filed on Jun. 11, 2013, the entire contents of which are incorporated herein by reference.

### FIELD

This invention relates to a numerical calculation method and apparatus.

### BACKGROUND

As numerical calculation methods for solving the behavior of a continuum such as a fluid or an elastic body, the finite difference method, the finite element method, the finite volume method and the like are known, which calculate approximate solutions of differential equations based on a mesh. Recently, in order to utilize the numerical calculation in a field such as the Computer Aided Engineering (CAE) or the like, these numerical calculation methods are developed, and a problem is solved, in which a fluid and structure interact each other. However, in the methods using the mesh, it is complicated to handle a problem in which an interface such as a free surface exists or a problem in which a moving boundary occurs such as a problem of the interaction between a fluid and a structure. Therefore, it is difficult to create programs.

On the other hand, in a particle method without using the mesh (e.g. Moving Particle Semi-implicit (MPS) method, Smoothed Particle Hydrodynamics (SPH) method, or the like), any special treatment for the moving boundary is not required. Therefore, recently, the particle method is being widely used.

Moreover, as a method for performing high-precision calculation by the particle method, a calculation method using the Riemann solver is known. A certain document discloses a technique for accurately performing simulation by preventing the vibration of the pressure, which is a problem in the calculation of the particle method.

For example, there is a document, which discloses a technique for making the calculation highly accurate by introducing the calculation method (which is called “Riemann solver”) that uses the solutions of the Riemann problem in one-dimensional equations of the inviscid fluid.

Here, an example of a method for introducing the Riemann solver into the particle method will be simply explained. Equations (0-1) to (0-3) of the slightly compressible fluid are considered as follows:

$$\begin{matrix}\frac{D ρ}{Dt} = - ρ ∇ \cdot v & ( 0 \text{-} 1 ) \\ \frac{Dv}{Dt} = - \frac{1}{ρ} ∇ p & ( 0 \text{-} 2 ) \\ p = {c}^{2} ( ρ - {ρ}_{0} ) & ( 0 \text{-} 3 )\end{matrix}$$

The equation (0-1) represents the law of conservation of mass, the equation (0-2) represents the law of conservation of momentum, and the equation (0-3) represents an equation of state. Here, v (thick v) represents a velocity vector of the fluid, p represents the density, p represents the pressure, and ρ₀ represents the density (i.e. reference or criterion density) when the pressure becomes zero. Moreover, c represents the sonic speed, and t represents the time.

Then, the equations (0-1) to (0-3) are discretized as follows:

$$\begin{matrix} {x}_{i}^{n + \frac{1}{2}} = {x}_{i}^{n} + \frac{dt}{2} {v}_{i}^{n} & ( 0 \text{-} 4 ) \\ {v}_{i}^{n + 1} = {v}_{i}^{n} - 2 dt {\sum }_{j}^{ } {m}_{j} ( \frac{{p}_{ij}^{n + \frac{1}{2}}}{{ρ}_{j}^{n} {ρ}_{i}^{n}} ) \frac{{x}_{ij}^{n + \frac{1}{2}}}{\vert {x}_{ij}^{n + \frac{1}{2}} \vert} \frac{\partial W ( \vert {x}_{ij}^{n + \frac{1}{2}} \vert , h )}{\partial {x}_{i}^{n + \frac{1}{2}}} & ( 0 \text{-} 5 ) \\ {ρ}_{i}^{n + 1} = {ρ}_{i}^{n} + 2 dt {\sum }_{j}^{ } {m}_{j} \frac{{ρ}_{i}}{{ρ}_{j}} ( {v}_{i}^{{l}_{ij} , n + \frac{1}{2}} - {v}_{ij}^{{l}_{ij} , n + \frac{1}{2}} ) \frac{\partial }{\partial ( \vert {x}_{ij}^{n + \frac{1}{2}} \vert )} W ( \vert {x}_{ij}^{n + \frac{1}{2}} \vert , h ) & ( 0 \text{-} 6 ) \\ {x}_{i}^{n + 1} = {x}_{i}^{n + \frac{1}{2}} + \frac{dt}{2} {v}_{i}^{n + 1} & ( 0 \text{-} 7 )\end{matrix}$$

Here, x (thick x) represents a position vector in the three-dimensional space. Moreover, xᵢ, vᵢ, ρᵢ and mᵢ respectively represent the position vector, velocity vector, density and mass of a particle i. xᵢⱼ^{n+1/2} represents a relative position vector of particles i and j. Specifically, it is represented as follows:

xᵢⱼ^{n+1/2}=xᵢ^{n+1/2}−xⱼ^{n+1/2}

Moreover, the upper index represents the time as the simulation step. Moreover, the symbols included in the aforementioned equations (0-4) to (0-7) are defined as follows:

$$\begin{matrix}{v}_{i}^{{l}_{ij} , n + \frac{1}{2}} = ( \frac{{v}_{i}^{n} + {v}_{i}^{n + 1}}{2} ) \cdot \frac{{x}_{i}^{n + \frac{1}{2}} - {x}_{j}^{n + \frac{1}{2}}}{\vert {x}_{i}^{n + \frac{1}{2}} - {x}_{j}^{n + \frac{1}{2}} \vert} & ( 0 \text{-} 8 ) \\ {l}_{ij} = \frac{{x}_{i}^{n + \frac{1}{2}} - {x}_{j}^{n + \frac{1}{2}}}{\vert {x}_{i}^{n + \frac{1}{2}} - {x}_{j}^{n + \frac{1}{2}} \vert} & ( 0 \text{-} 9 )\end{matrix}$$

Furthermore, W represents a kernel function (also called “weight function”), and the following spline function is used frequently for W:

$$W ( r , h ) = \{ \begin{matrix}\frac{( 1 - 1.5 {( \frac{r}{h} )}^{2} + 0.75 {( \frac{r}{h} )}^{3} )}{β} & 0 \leq \frac{r}{h} < 1 , \\ \frac{0.25 {( 2 - \frac{r}{h} )}^{3}}{β} & 1 \leq \frac{r}{h} < 2 , \\ 0 & 2 \leq \frac{r}{h} .\end{matrix} \qquad ( 0 \text{-} 10 )$$

Here, h represents an influence radius between particles, and about double or triple of an average particle interval at the initial state is used frequently for “h”. β is a value that is adjusted so that the entire-space integral quantity of the kernel function becomes “1”, and β in the two-dimensional space is determined as 0.7 nh², and β in the three-dimensional space is determined as nh³.

The expressions (0-8) and (0-9) represent intermediate values between the particles i and j, and one-dimensional equation of the fluid is solved numerically to use the solution when advancing the time by dt/2. In other words, as illustrated in FIG. 1, an axis l_{id} is set between the particles i and j, and the velocity vectors that are projected to the vector on this axis are respectively represented as follows:

vⱼ^{l}^{_{ij,n}}=vⱼⁿ·lᵢⱼ

vᵢ^{l}^{_{ij,n}}=vᵢⁿ·lᵢⱼ

The specific determination method is as follows: Firstly, as for the equations (0-1) to (0-3), the equations in case that the space is one-dimensional are put in order as follows:

$$\frac{\partial }{\partial t} ( \begin{matrix}ρ \\ v\end{matrix} ) = - \frac{\partial }{\partial x} ( \begin{matrix}ρ v \\ \frac{{v}^{2}}{2} + {c}^{2} log ρ\end{matrix} ) \qquad ( 0 \text{-} 11 )$$

Then, the equation (0-11) is rewritten in a format of the characteristic equation by using the Riemann invariants q⁺ and q⁻.

$$\begin{matrix}\frac{\partial {q}^{+}}{\partial t} = - ( v + c ) \frac{\partial {q}^{+}}{\partial x} & ( 0 \text{-} 12 ) \\ \frac{\partial {q}^{-}}{\partial t} = - ( v - c ) \frac{\partial {q}^{-}}{\partial x} \\ {q}^{+} = log ρ + \frac{v}{c} \\ {q}^{-} = log ρ - \frac{v}{c} & ( 0 \text{-} 13 )\end{matrix}$$

Then, as for the particles i and j at time n, q⁺ and q⁻ are represented as follows:

$${q}_{i}^{n , +} = log {ρ}_{i}^{n} + \frac{{v}_{i}^{{l}_{ij} , n}}{c}$$

$${q}_{i}^{n , -} = log {ρ}_{i}^{n} - \frac{{v}_{i}^{{l}_{ij} , n}}{c}$$

$$\begin{matrix}{v}_{i}^{{l}_{ij} , n} = {v}_{i}^{n} \cdot \frac{{x}_{i}^{n + \frac{1}{2}} - {x}_{j}^{n + \frac{1}{2}}}{\vert {x}_{i}^{n + \frac{1}{2}} - {x}_{j}^{n + \frac{1}{2}} \vert} \\ = {v}_{i}^{n} \cdot {l}_{ij}\end{matrix}$$

Furthermore, the spatial gradient is calculated as follows:

$$∇ q {{\vert}_{i}^{n , +} = ∇ log ( ρ ) \vert}_{i}^{n} + \frac{{[ {∇}_{v} {\vert}_{i}^{n} ]}^{T} {l}_{ij}}{c}$$

$$∇ q {{\vert}_{i}^{n , -} = ∇ log ( ρ ) \vert}_{i}^{n} - \frac{{[ {∇}_{v} {\vert}_{i}^{n} ]}^{T} {l}_{ij}}{c}$$

$$∇ q {{\vert}_{j}^{n , +} = ∇ log ( ρ ) \vert}_{j}^{n} + \frac{{[ {∇}_{v} {\vert}_{j}^{n} ]}^{T} {l}_{ij}}{c}$$

$$∇ q {{\vert}_{j}^{n , -} = ∇ log ( ρ ) \vert}_{j}^{n} - \frac{{[ {∇}_{v} {\vert}_{j}^{n} ]}^{T} {l}_{ij}}{c}$$

After preparing the variables as described above, as illustrated in FIG. 2, a problem (i.e. Riemann problem) is considered that uses, as an initial value, a situation that a surface whose physical quantity is discontinuous exists between the particles i and j, and by using analytic solutions of the equations (0-12) and (0-13), values of q⁺ and q⁻ at the middle between the particles i and j and at time n+½ are predicted. Specifically, the values are calculated as follows:

$$\begin{matrix}{q}_{ij}^{n + \frac{1}{2} , +} = {q}_{j}^{n , +} + ( \frac{\vert {x}_{ij}^{n + \frac{1}{2}} \vert}{2} - \frac{cdt}{2} ) ( {l}_{ij} \cdot ∇ q {\vert}_{j}^{n , +} ) & ( 0 \text{-} 14 ) \\ {q}_{ij}^{n + \frac{1}{2} , -} = {q}_{j}^{n , +} - ( \frac{\vert {x}_{ij}^{n + \frac{1}{2}} \vert}{2} - \frac{cdt}{2} ) ( {l}_{ij} \cdot ∇ q {\vert}_{j}^{n , -} ) \\ {ρ}_{ij}^{n + \frac{1}{2}} = exp ( \frac{{q}_{ij}^{n + \frac{1}{2} , +} + {q}_{ij}^{n + \frac{1}{2} , -}}{2} ) & ( 0 \text{-} 15 ) \\ {v}_{ij}^{n + \frac{1}{2}} = c ( \frac{{q}_{ij}^{n + \frac{1}{2} , +} - {q}_{ij}^{n + \frac{1}{2} , -}}{2} ) & ( 0 \text{-} 16 ) \\ {p}_{ij}^{n + \frac{1}{2}} = {c}^{2} ( {ρ}_{ij}^{n + \frac{1}{2}} + {ρ}_{0} ) & ( 0 \text{-} 17 )\end{matrix}$$

By substituting the equations (0-16) and (0-17) into the equations (0-5) and (0-6), the simulation in the particle method is accurately performed.

On the other hand, as for the calculation of the interaction between the rigid body and the fluid and simulation of the interflow phenomenon of the separate liquids (e.g. water and oil) that are not mixed, the particle method is expected that can easily handle the free surface or moving boundary. In case of the inter flow phenomenon, because the liquids whose densities are different in a stable state are handled, it is difficult to perform the calculation only by using the standard SPH method, typically.

As a calculation method that handles the interflow of the liquids whose densities are different by the particle method, a certain document discloses the following calculation. In other words, as the equations of the liquids whose densities are different, following equations (0-18) to (0-21) are used.

$$\begin{matrix}\frac{D ρ}{Dt} = - ρ ∇ \cdot v & ( 0 \text{-} 18 ) \\ \frac{Dv}{Dt} = - \frac{1}{ρ} ∇ p + g & ( 0 \text{-} 19 ) \\ p = {c}^{2} ( ρ - {ρ}_{s} ( x , t ) ) & ( 0 \text{-} 20 ) \\ \frac{D {ρ}_{s}}{Dt} = 0 & ( 0 \text{-} 21 )\end{matrix}$$

g represents the acceleration due to the gravity, and ρₛ represents the reference or criterion density. The point that is different from the equations (0-1) to (0-3) is that the reference or criterion density is different depending on the position. The spatial change of the reference density represents the interflow of the different liquids.

Then, the equations (0-18) to (0-21) are discretized for each particle by the SPH method as follows:

$$\begin{matrix} \frac{d {ρ}_{i}}{d t} = {\sum }_{j}^{ } {m}_{j} ( {v}_{i} - {v}_{j} ) \cdot \frac{\partial W ( \vert {x}_{i} - {x}_{j} \vert )}{\partial {x}_{i}} & ( 0 \text{-} 22 ) \\ \frac{d {v}_{i}}{d t} = g - {\sum }_{j}^{ } {m}_{j} [ ( \frac{{p}_{j} + {p}_{i}}{{ρ}_{j} {ρ}_{i}} ) - \frac{ξ}{{ρ}_{j} {ρ}_{i}} \frac{4 {μ}_{i} {μ}_{j}}{( {μ}_{i} + {μ}_{j} )} \frac{{v}_{ij} \cdot {x}_{ij}}{{\vert {x}_{ij} \vert}^{2} + {η}^{2}} ] \frac{\partial W ( \vert {x}_{i} - {x}_{j} \vert )}{\partial {x}_{i}} & ( 0 \text{-} 23 ) \\ {p}_{i} = {c}^{2} ( {ρ}_{i} - {ρ}_{s , i} ) & ( 0 \text{-} 24 )\end{matrix}$$

The equation (0-22) represents the law of conservation of mass, and the equation (0-23) represents the law of conservation of momentum, and the equation (0-24) represents the equation of the state. ζ and n are constant parameters. Here, ρ_{s,i} represents the reference or criterion density of the particle i.

xᵢⱼ=xᵢ−xⱼ

vᵢⱼ=vᵢ−vⱼ

As for the equations (0-22) to (0-24), the simulation becomes possible by calculating the temporal development by the Euler's method, the leap flog method or the like, which is a numerical analysis method of the typical ordinary differential equations.

However, it is impossible to apply the high-precision calculation by the Riemann solver used in the particle method to the basic equations (0-18) to (0-21) in this technique. Therefore, the calculation accuracy is lowered for the interflow of the liquids that have different density.

In other words, there is no technique for performing the numerical high-precision calculation of the interflow phenomenon of the liquids having different reference or criterion densities.
Patent Document 1: International Publication Pamphlet No. WO 2012/111082
Non-Patent Document 1: Shu-ichiro Inutsuka, “Reformulation of Smoothed Particle Hydrodynamics with Riemann Solver”, Journal of Computational Physics, vol. 179, pp. 238-267, Jun. 10, 2002
Non-Patent Document 2: Paul W. Cleary, “Extension of SPH to predict feeding, freezing and defect creation in low pressure die casting”, Applied Mathematical Modelling, vol. 34, pp. 3189-3201, November 2010

### SUMMARY

A numerical calculation method relating to this invention includes: (A) performing a first processing for each second particle of second particles that are identified from a positional relationship with a first particle among a plurality of first particles, wherein the plurality of first particles relate to a first fluid that has a first reference density, and a plurality of second particles relate to a second fluid that has a second reference density, and the first processing comprises: (a1) first calculating a first physical quantity obtained by using, in a Riemann invariant, a ratio of a first density of the first particle to the first reference density, instead of the first density; (a2) second calculating a second physical quantity obtained by using, in the Riemann invariant, a ratio of a second density of the second particle to the second reference density, instead of the second density; (a3) third calculating a gradient of the first physical quantity and a gradient of the second physical quantity; (a4) fourth calculating a time-space intermediate value for the first and second physical quantities between the first particle and the second particle, by using the first physical quantity, the second physical quantity, the gradient of the first physical quantity and the gradient of the second physical quantity; (a5) fifth calculating a time-space intermediate value for pressure between the first particle and the second particle, by using the time-space intermediate value for the first and the second physical quantities; and (a6) sixth calculating a time-space intermediate value for a velocity between the first particle and the second particle, by using the time-space intermediate value for the first and second physical quantities; (B) first updating a velocity of the first particle by using the calculated time-space intermediate value for the pressure; and (C) second updating the first density of the first particle based on the calculated time-space intermediate value for the velocity.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram to explain an intermediate value of particles and j;

FIG. 2 is a diagram depicting a situation that a surface whose physical quantity is discontinuous between the particles i and j exists;

FIG. 3 is a diagram depicting an example of an interflow presumed in this embodiment;

FIG. 4 is a functional block diagram of an information processing apparatus relating to this embodiment;

FIG. 5 is a diagram depicting a processing flow of a processing in this embodiment;

FIG. 6 is a diagram depicting a processing flow of the processing in this embodiment;

FIG. 7 is a diagram depicting a processing flow of the processing in this embodiment;

FIG. 8 is a diagram depicting a processing flow of the processing in this embodiment;

FIG. 9 is a diagram depicting a processing flow of the processing in this embodiment;

FIG. 10 is a diagram depicting a processing flow of the processing in this embodiment; and

FIG. 11 is a functional block diagram of a computer.

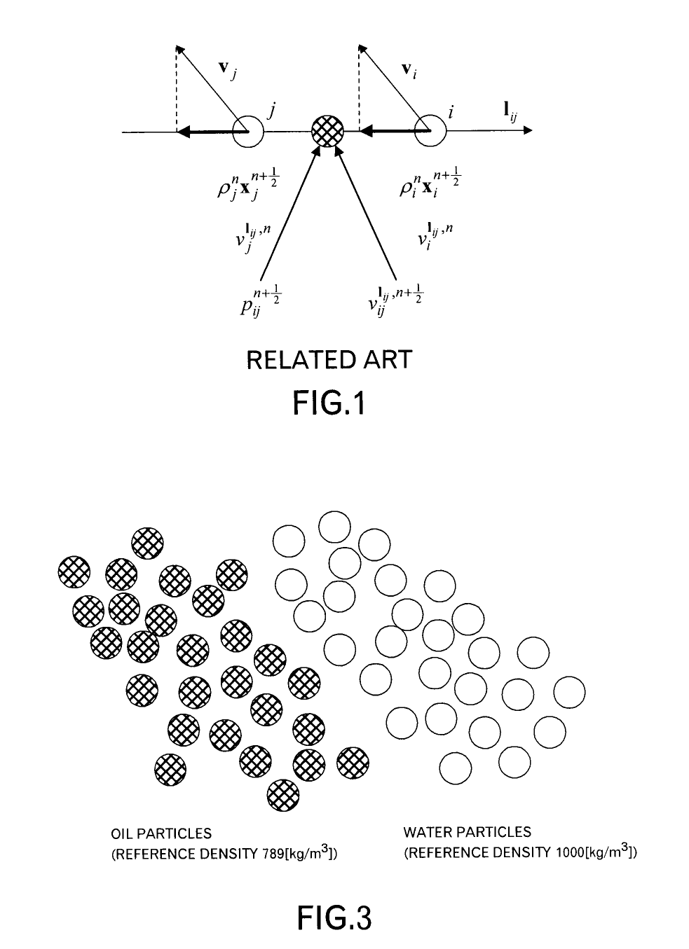

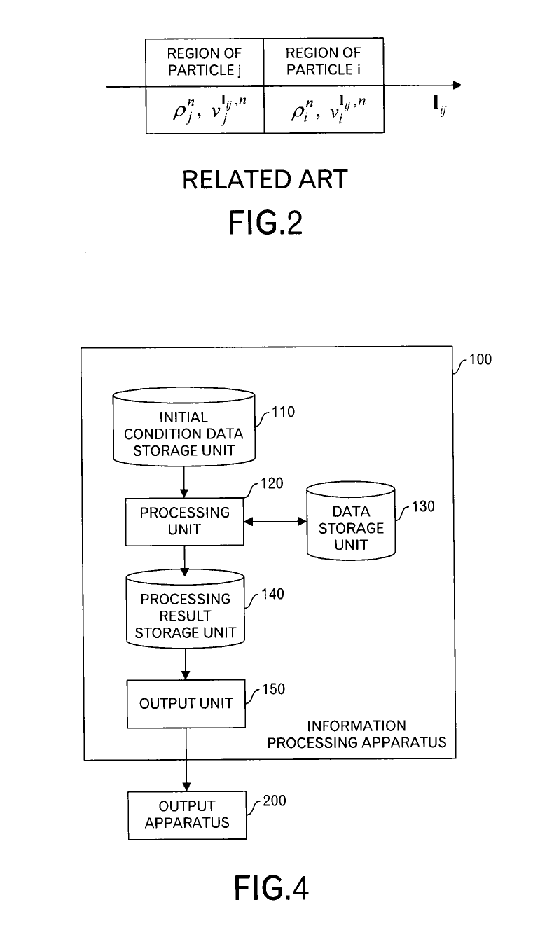

### DESCRIPTION OF EMBODIMENTS

Firstly, an approach of the calculation relating to an embodiment of this invention will be explained.

In this embodiment, the equations that represent the following fluid momentum are solved by the particle method.

$$\begin{matrix}\frac{D ρ}{Dt} = - ρ ∇ \cdot v & ( 1 ) \\ ρ \frac{Dv}{Dt} = - ∇ p & ( 2 ) \\ p = {c}^{2} ( ρ - {ρ}_{s} ( x , t ) ) & ( 3 ) \\ \frac{D {ρ}_{s}}{Dt} = 0 & ( 4 )\end{matrix}$$

Here, v and p respectively represent a velocity field and a pressure field of the fluid. Moreover, p and ρₛ respectively represent the density and reference or criterion density (i.e. density in the state that the pressure is zero) of the fluid. Moreover, c represents the sonic speed.

The equations (1) to (4) are used in a case where the interflow of the liquids whose densities are different and which are not mixed like the water and oil as illustrated in FIG. 3.

When the equations (1) to (4) are spatially discretized in the particle method, following equations are obtained.

$$\begin{matrix}\frac{d {ρ}_{i}}{d t} = {ρ}_{i} {\sum }_{j}^{ } \frac{{m}_{j}}{{ρ}_{j}} ( {v}_{i} - {v}_{j} ) \cdot \frac{\partial W ( \vert {x}_{i} - {x}_{j} \vert , h )}{\partial {x}_{i}} & ( 5 ) \\ {m}_{i} \frac{d {v}_{i}}{d t} = - {m}_{i} {\sum }_{j}^{ } {m}_{j} ( \frac{{p}_{j} + {p}_{i}}{{ρ}_{j} {ρ}_{i}} ) \frac{\partial W ( \vert {x}_{i} - {x}_{j} \vert , h )}{\partial {x}_{i}} & ( 6 ) \\ {p}_{i} = {c}^{2} ( {ρ}_{i} - {ρ}_{s , i} ) & ( 7 )\end{matrix}$$

j represents other particles included in an influenced range, for example.

Furthermore, following recursion formulas are derived by discretizing the equations by the time.

$$\begin{matrix} {x}_{i}^{n + \frac{1}{2}} = {x}_{i}^{n} + \frac{dt}{2} {v}_{i}^{n} & ( 8 ) \\ {v}_{i}^{n + 1} = {v}_{i}^{n} - 2 dt {\sum }_{j}^{ } {m}_{j} ( \frac{{p}_{ij}^{n + \frac{1}{2}}}{{ρ}_{j}^{n} {ρ}_{i}^{n}} ) \frac{{x}_{ij}^{n + \frac{1}{2}}}{\vert {x}_{ij}^{n + \frac{1}{2}} \vert} \frac{\partial W ( \vert {x}_{ij}^{n + \frac{1}{2}} \vert , h )}{\partial {x}_{i}^{n + \frac{1}{2}} } & ( 9 ) \\ {ρ}_{i}^{n + 1} = {ρ}_{i}^{n} + 2 dt {\sum }_{j}^{ } {m}_{j} \frac{{ρ}_{i}^{n}}{{ρ}_{j}^{n}} ( \frac{{v}_{i}^{{l}_{ij} , n } + {v}_{i}^{{l}_{ij} , n + 1}}{2} - {v}_{ij}^{{l}_{ij} , n + \frac{1}{2}} ) \frac{\partial }{\partial ( \vert {x}_{ij}^{n + \frac{1}{2}} \vert )} W ( \vert {x}_{ij}^{n + \frac{1}{2}} \vert , h ) & ( 10 ) \\ {x}_{i}^{n + 1} = {x}_{i}^{n + \frac{1}{2}} + \frac{dt}{2} {v}_{i}^{n + 1} & ( 11 )\end{matrix}$$

Here, dt represents a time interval, and other symbols respectively have following meanings.

$${l}_{ij} = \frac{{x}_{i}^{n + \frac{1}{2}} - {x}_{j}^{n + \frac{1}{2}}}{\vert {x}_{i}^{n + \frac{1}{2}} - {x}_{j}^{n + \frac{1}{2}} \vert}$$

$${v}_{i}^{{l}_{ij} , n} = {v}_{i}^{n} \cdot {l}_{ij}$$

$${v}_{i}^{{l}_{ij} , n + 1} = {v}_{i}^{n + 1} \cdot {l}_{ij}$$

As represented in the expression (10), portions other than ρⁿᵢ/ρⁿⱼ in the second term of the right side in the density of temporal development includes values at time n+½ and average values of values at times n and (n+1). Then, when the temporal change of ρⁿᵢ/ρⁿⱼ. is small, this is a calculation method that has the second-order accuracy.

vᵢⱼ^{lij n+1/2} and pᵢⱼ^{lij,n+1/2} are intermediate values between the particles i and j, and are calculated by following procedure.

Firstly, the linear equations for the equations (1) to (4) are considered.

$$\frac{\partial ρ}{\partial t} = - ρ \frac{\partial v}{\partial x} - v \frac{\partial ρ}{\partial x}$$

$$\frac{\partial v}{\partial t} = - \frac{\partial }{\partial x} ( \frac{{v}^{2 }}{2} + {c}^{2} log \frac{ρ}{{ρ}_{s}} ) - {c}^{2} \frac{\partial log {ρ}_{s}}{\partial x} + \frac{{c}^{2}}{ρ} \frac{\partial {ρ}_{s}}{\partial x}$$

Here, by transforming the Riemann invariants by using ρ/ρₛ instead of ρ, following physical quantities are newly introduced.

$${q}^{+} = log ( \frac{ρ}{{ρ}_{s}} ) + \frac{v}{c}$$

$${q}^{-} = log ( \frac{ρ}{{ρ}_{s}} ) - \frac{v}{c}$$

Then, when putting equations in order by these physical quantities, following equations are obtained.

$$\begin{matrix}\frac{\partial {q}^{+}}{\partial t} = - ( v + c ) \frac{\partial {q}^{+}}{\partial x} - \frac{1}{{ρ}_{s}} \frac{D {ρ}_{s}}{Dt} + c ( \frac{{ρ}_{s}}{ρ} - 1 ) \frac{\partial log {ρ}_{s}}{\partial x} & ( 11 \text{-} 1 ) \\ \frac{\partial {q}^{-}}{\partial t} = - ( v - c ) \frac{\partial {q}^{-}}{\partial x} - \frac{1}{{ρ}_{s}} \frac{D {ρ}_{s}}{Dt} - c ( \frac{{ρ}_{s}}{ρ} - 1 ) \frac{\partial log {ρ}_{s}}{\partial x} & ( 11 \text{-} 2 )\end{matrix}$$

When considering only the first term of the right side of the equations (11-1) and (11-2), they have similar forms to the equations (0-12) and (0-13). Therefore, by considering only the first term of the right side to perform the temporal development as follows and adding the terms that compensate for the second and third terms of the right side later, the calculation is performed. A) More specifically, the variables q⁺ and q⁻ are calculated as follows:

$$\begin{matrix}{q}_{i}^{n , +} = log ( \frac{{ρ}_{i}^{n}}{{ρ}_{i , s}^{n}} ) + \frac{{v}_{i}^{{l}_{ij} , n}}{c} & ( 12 ) \\ {q}_{i}^{n , -} = log ( \frac{{ρ}_{i}^{n}}{{ρ}_{i , s}^{n}} ) - \frac{{v}_{i}^{{l}_{ij} , n}}{c} & ( 13 ) \\ {q}_{j}^{n , +} = log ( \frac{{ρ}_{j}^{n}}{{ρ}_{j , s}^{n}} ) + \frac{{v}_{j}^{{l}_{ij} , n}}{c} & ( 14 ) \\ {q}_{j}^{n , -} = log ( \frac{{ρ}_{j}^{n}}{{ρ}_{j , s}^{n}} ) - \frac{{v}_{j}^{{l}_{ij} , n}}{c} & ( 15 )\end{matrix}$$

These are the aforementioned physical quantities for the particles i and j at time n. B) Moreover, the gradients of the variables q⁺ and q⁻ are calculated as follows:

$$\begin{matrix}∇ q {\vert}_{i}^{n , +} = ∇ log ( ρ ) {\vert}_{i}^{n} - ∇ log ( {ρ}_{s} ) {\vert}_{i}^{n} + \frac{{[ ∇ v {\vert}_{i}^{n} ]}^{T} {l}_{ij}}{c} & ( 16 ) \\ ∇ q {\vert}_{i}^{n , -} = ∇ log ( ρ ) {\vert}_{i}^{n} - ∇ log ( {ρ}_{s} ) {\vert}_{i}^{n} - \frac{{[ ∇ v {\vert}_{i}^{n} ]}^{T} {l}_{ij}}{c} & ( 17 ) \\ ∇ q {\vert}_{j}^{n , +} = ∇ log ( ρ ) {\vert}_{j}^{n} - ∇ log ( {ρ}_{s} ) {\vert}_{j}^{n} + \frac{{[ ∇ v {\vert}_{j}^{n} ]}^{T} {l}_{ij}}{c} & ( 18 ) \\ ∇ q {\vert}_{j}^{n , -} = ∇ log ( ρ ) {\vert}_{j}^{n} - ∇ log ( {ρ}_{s} ) {\vert}_{j}^{n} - \frac{{[ ∇ v {\vert}_{j}^{n} ]}^{T} {l}_{ij}}{c} & ( 19 )\end{matrix}$$

The symbols in the equations (16) to (19) are represented as follows:

$$\begin{matrix}∇ log ( ρ ) {\vert}_{i}^{n} = {\sum }_{k}^{ } \frac{{m}_{k}}{{ρ}_{i}^{n}} ( log ( {ρ}_{k}^{n} ) - log ( {ρ}_{i}^{n} ) ) \frac{\partial W ( \vert {x}_{i}^{n + \frac{1}{2}} - {x}_{k}^{n + \frac{1}{2}} \vert , h )}{\partial {x}_{i}^{n + \frac{1}{2}}} & ( 20 ) \\ ∇ log ( {ρ}_{s} ) {\vert}_{i}^{n} = {\sum }_{k}^{ } \frac{{m}_{k}}{{ρ}_{i}^{n}} ( log ( {ρ}_{s , k}^{n} ) - log ( {ρ}_{s , i}^{n} ) ) \frac{\partial W ( \vert {x}_{i}^{n + \frac{1}{2}} - {x}_{k}^{n + \frac{1}{2}} \vert , h )}{\partial {x}_{i}^{n + \frac{1}{2}}} & ( 21 ) \\ \begin{matrix}{[ ∇ v {\vert}_{i}^{n} ]}^{T} {l}_{ij} = ∇ {v}^{{l}_{ij}} {\vert}_{i}^{n} \\ = {\sum }_{k}^{ } \frac{{m}_{k}}{{ρ}_{k}} ( ( {v}_{k}^{n} - {v}_{i}^{n} ) \cdot {l}_{ij} ) \frac{\partial W ( \vert {x}_{i}^{n + \frac{1}{2}} - {x}_{k}^{n + \frac{1}{2}} \vert )}{\partial {x}_{i}^{n + \frac{1}{2}}}\end{matrix} & ( 22 )\end{matrix}$$

The equation (21) represents that the gradients of the variables q⁺ and q⁻ are calculated by using the spatial gradient of the reference or criterion density based on the relation with the reference or criterion densities of other particles. In other words, this portion is a difference with a case other than the interflow, which was explained in the column of the related art. C) As for the variables q⁺ and q⁻, the intermediate values between the particles i and j are calculated as follows:

$$\begin{matrix}{q}_{ij}^{n + \frac{1}{2} , +} = {q}_{j}^{n , +} + ( \frac{\vert {x}_{ij}^{n + \frac{1}{2}} \vert}{2} - \frac{cdt}{2} ) ( \frac{{x}_{ij}^{n + \frac{1}{2}}}{\vert {x}_{ij}^{n + \frac{1}{2}} \vert} \cdot ∇ q {\vert}_{j}^{n , +} ) - \frac{dt}{{ρ}_{s , ij}^{n}} \frac{D {ρ}_{s}}{Dt} {\vert}_{j} - \frac{cdt}{2} ( 1 - \frac{{ρ}_{s , ij}^{2}}{{ρ}_{ij}^{n}} ) \frac{{x}_{ij}^{n + \frac{1}{2}}}{\vert {x}_{ij}^{n + \frac{1}{2}} \vert} \cdot ∇ {ρ}_{s} {\vert}_{j}^{n} & ( 23 ) \\ {q}_{ij}^{n + \frac{1}{2} , -} = {q}_{j}^{n , -} + ( \frac{\vert {x}_{ij}^{n + \frac{1}{2}} \vert}{2} + \frac{cdt}{2} ) ( \frac{{x}_{ij}^{n + \frac{1}{2}}}{\vert {x}_{ij}^{n + \frac{1}{2}} \vert} \cdot ∇ q {\vert}_{j}^{n , -} ) - \frac{dt}{{ρ}_{s , ij}^{n}} \frac{D {ρ}_{s}}{Dt} {\vert}_{i} + \frac{cdt}{2} ( 1 - \frac{{ρ}_{s , ij}^{2}}{{ρ}_{ij}^{n}} ) \frac{{x}_{ij}^{n + \frac{1}{2}}}{\vert {x}_{ij}^{n + \frac{1}{2}} \vert} \cdot ∇ {ρ}_{s} {\vert}_{i}^{n} & ( 24 )\end{matrix}$$

The second term of the right side in each of the equations (23) and (24) is similar to the second term of the right side in the corresponding one of the equations (0-14) and (0-15), so it is understood that they are obtained by using the approach of the Riemann solver.

ρᵢⱼⁿ and ρ_{s,ij}ⁿ are intermediate values of the density and reference or criterion density between the particles i and j, and they are represented as follows:

ρᵢⱼⁿ=\sqrt{ρᵢⁿρⱼⁿ}

ρ_{s,ij}ⁿ=\sqrt{ρ_{s,i}ⁿρ_{s,j}ⁿ}

The third and fourth terms of the right side in each of the equations (23) and (24) are obtained by the differential approximation of the second and third terms of the right side in the corresponding one of the equations (11-1) and (11-2). There is no problem even if “0” is set to Dρₛ/Dt|ᵢ and Dρₛ/Dt|ⱼ in the third term of the right side in the equations (23) and (24). Moreover, the spatial differential of the reference or criterion density is represented as follows, and is obtained by the calculation method of the standard SPH method.

$$∇ {ρ}_{s} {\vert}_{i}^{n} = {\sum }_{k}^{ } \frac{{m}_{k}}{{ρ}_{i}^{n}} ( {ρ}_{s , k}^{n} - {ρ}_{s , i}^{n} ) \frac{\partial W ( \vert {x}_{i}^{n + \frac{1}{2}} - {x}_{k}^{n + \frac{1}{2}} \vert , h )}{\partial {x}_{i}^{n + \frac{1}{2}}}$$

D) The intermediate values for the velocity and pressure are calculated by the equations (27) and (28) by using the calculated intermediate values qᵢⱼ^{n+1/2,+} and qᵢⱼ^{n+1/2,-}, and they are substituted into the equations (9) and (10).

$$\begin{matrix}{ρ}_{ij}^{n + \frac{1}{2}} = {ρ}_{s , ij} exp ( \frac{{q}_{ij}^{n + \frac{1}{2} , +} + {q}_{ij}^{n + \frac{1}{2} , -}}{2} ) & ( 26 ) \\ {v}_{ij}^{n + \frac{1}{2}} = c ( \frac{{q}_{ij}^{n + \frac{1}{2} , +} + {q}_{ij}^{n + \frac{1}{2} , -}}{2} ) & ( 27 ) \\ {p}_{ij}^{n + \frac{1}{2}} = {c}^{2} ( {ρ}_{ij}^{n + \frac{1}{2}} - {ρ}_{s , ij}^{n} ) & ( 28 )\end{matrix}$$

A specific processing and an apparatus for performing the specific processing based on the aforementioned approach will be explained.

FIG. 4 illustrates a functional block diagram of an information processing apparatus 100 relating to this embodiment. The information processing apparatus 100 has an initial condition data storage unit 110, a processing unit 120, a data storage unit 130, a processing result storage unit 140 and an output unit 150. Then, the information processing apparatus 100 is connected to an output apparatus 200.

Data concerning an initial position, initial velocity, initial density, reference or criterion density, time interval dt and external force that is pressed to the particle (e.g. gravity) is stored in the initial condition data storage unit 110.

The processing unit 120 uses data stored in the initial condition data storage unit 110 to calculate, for each time step and each particle, data concerning the velocity, density, position and the like, and stores the calculated data into the processing result storage unit 140. The data during the processing is stored in the data storage unit 130.

The output unit 150 outputs data stored in the processing result storage unit 140 to the output apparatus 200 (e.g. printer, display apparatus, or apparatus such as other computers connected to this information processing apparatus 100 via a network).

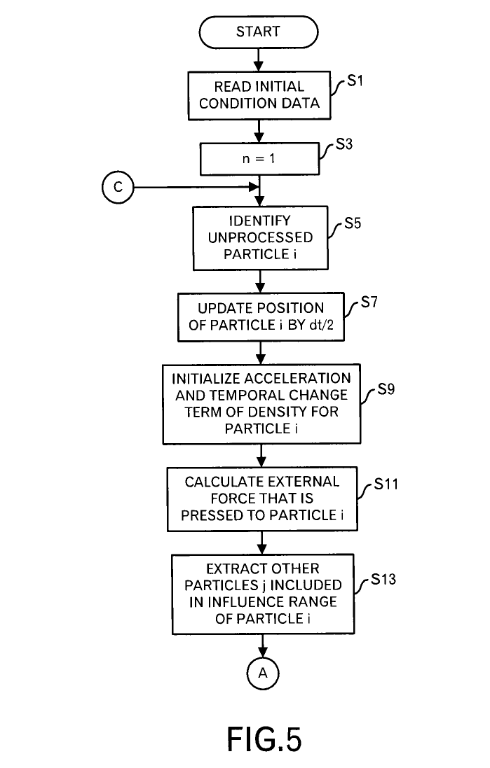

Next, processing contents of the information processing apparatus 100 will be explained by using FIGS. 5 to 10.

Firstly, the processing unit 120 reads out the initial condition data stored in the initial condition data storage unit 110 (FIG. 5: step S1). Moreover, the processing unit 120 sets n=1 (step S3).

Then, the processing unit 120 identifies one unprocessed particle i among particles for which the initial condition data is set (step S5).

After that, the processing unit 120 updates the position of the particle i by dt/2 (step S7). Specifically, the following calculation is performed. xᵢ¹ is included in the initial condition data.

$${x}_{i}^{n + \frac{1}{2}} = {x}_{i}^{n} + \frac{dt}{2} {v}_{i}^{n}$$

Moreover, the processing unit 120 initializes the acceleration of the particle i and a temporal change term of the density (step S9). Specifically, the following setting is performed.

$${a}_{i}^{n} = 0$$

$$\frac{d ρ}{d t} {\vert}_{i}^{n} = 0$$

Furthermore, the processing unit 120 calculates an external force that is pressed to the particle i (step S11). Specifically, a following calculation is performed. The external force fⁿᵢ is included in the initial condition data.

aᵢⁿ=aᵢⁿ+fᵢⁿ

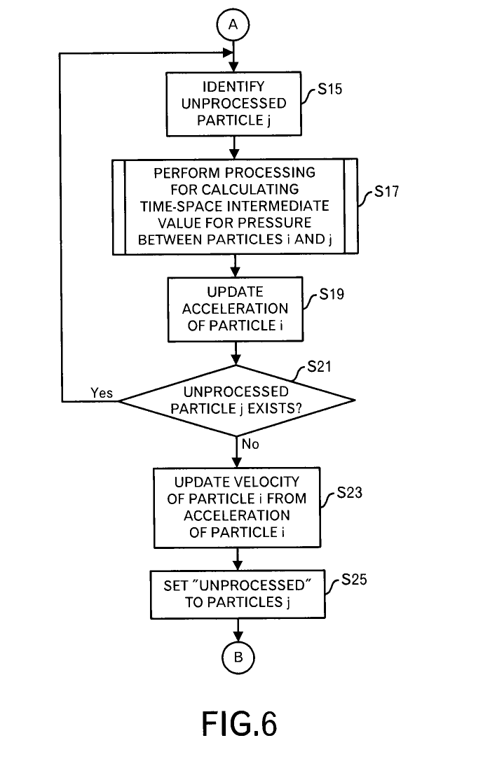

Furthermore, the processing unit 120 extracts other particles j, which are included in an influence range of the particle i (step S13). Then, the processing shifts to a processing in FIG. 6 through terminal A.

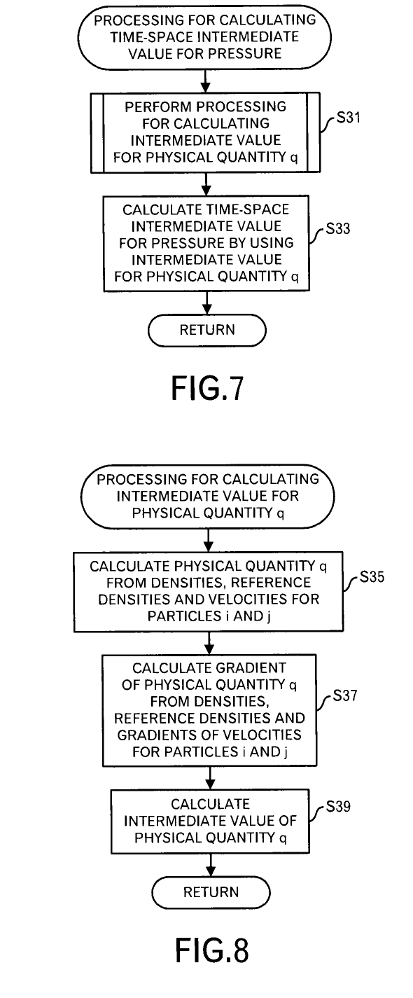

Shifting to the explanation of the processing in FIG. 6 through the terminal A, the processing unit 120 identifies one unprocessed particle j among extracted particles j (step S15). Then, the processing unit 120 performs a processing for calculating a time-space intermediate value for the pressure between the particles i and j (step S17). This processing will be explained by using FIGS. 7 and 8.

The processing unit 120 performs a processing for calculating an intermediate value of a physical quantity q (FIG. 7: step S31). Specifically, a processing in FIG. 8 is performed.

The processing unit 120 calculates the physical quantities q⁻ᵢ and q⁺ⱼ from the density, reference or criterion density and velocities of the particles i and j according to the equations (13) and (14) (step S35).

Moreover, the processing unit 120 calculates the gradient of the physical quantity q from the gradient of the density, reference or criterion density and velocities of the particles i and j according to the equations (17) and (18) (step S37).

Furthermore, the processing 120 calculates the time-space intermediate values qᵢⱼ^{n+1/2,+} and qᵢⱼ^{n+1/2,-} of the physical quantity q according to the equations (23) and (24) (step S39).

The calculation results obtained by the processing in FIG. 8 are stored in the data storage unit 130 if the capacity of the data storage unit 130 is sufficient. Then, the later processing may be omitted. When the capacity of the data storage unit 130 is not sufficient, the same calculation is performed in the later processing.

Returning to the explanation of the processing in FIG. 7, the processing unit 120 uses the time-space intermediate values of the physical quantity q to calculate the time-space intermediate value pᵢⱼ^{n+1/2} for the pressure according to the equation (28) (step S33).

The calculation of the time-space intermediate value pᵢⱼ^{n+1/2} for the pressure is performed prior to the calculation of the time-space intermediate value for the velocity. This is because the velocity vᵢⁿ⁺¹ is used for the calculation of the time-space intermediate value for the velocity.

Returning to the explanation of the processing in FIG. 6, the processing unit 120 updates the acceleration of the particle i by using the time-space intermediate value pᵢⱼ^{n+1/2} for the pressure (step S19). The calculation at this step is represented as follows:

$${a}_{i}^{n} = {a}_{i}^{n} - 2 {m}_{j} ( \frac{{p}_{ij}^{n + \frac{1}{2}}}{{ρ}_{j}^{n} {ρ}_{i}^{n}} ) \frac{{x}_{ij}^{n + \frac{1}{2}}}{\vert {x}_{ij}^{n + \frac{1}{2}} \vert} \frac{\partial W ( \vert {x}_{ij}^{n + \frac{1}{2}} \vert )}{\partial {x}_{i}^{n + \frac{1}{2}}}$$

After that, the processing unit 120 determines whether or not there is an unprocessed particle j among the particles extracted at the step S13 (step S21). When there is an unprocessed particle j, the processing returns to the step S15. On the other hand, when there is no unprocessed particle j, the processing unit 120 updates the velocity of the particle i from the acceleration of the particle i (step S23). The calculation at this step is represented as follows:

vᵢⁿ⁺¹=vᵢⁿ+dtaᵢⁿ

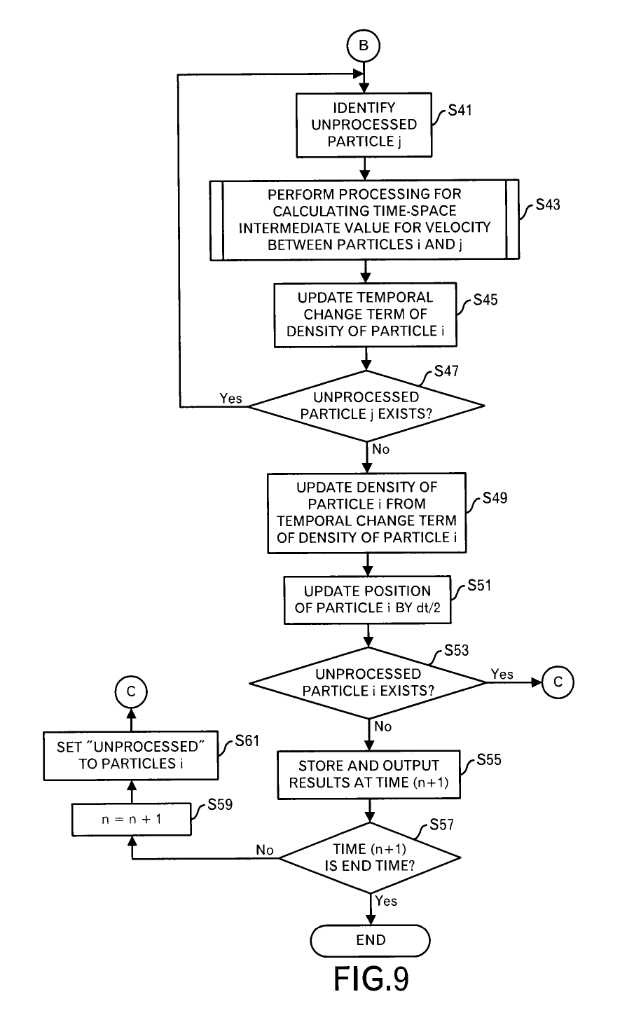

Then, the processing unit 120 sets “unprocessed” to the particles j extracted at the step S13 (step S25). The similar processing to the processing of the step S13 may be executed. The processing shifts to a processing in FIG. 9 through terminal B.

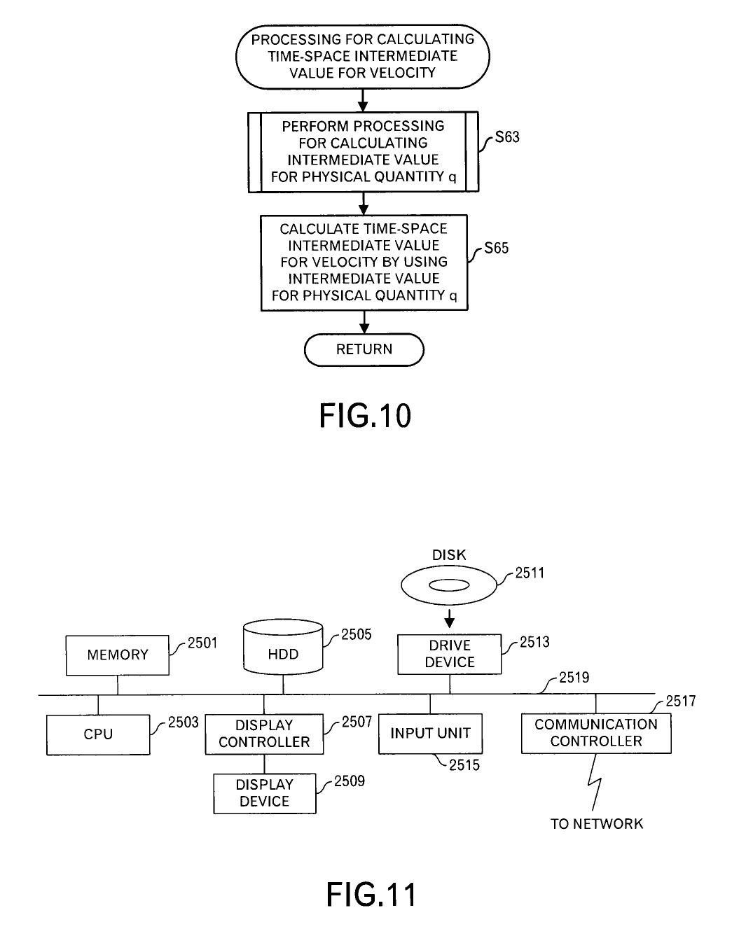

Shifting to the explanation of the processing in FIG. 9, the processing unit 120 identifies one unprocessed particle j among the particles extracted at the step S13 (step S41). Then, the processing unit 120 performs a processing for calculating a time-space intermediate value for the velocities of the particles i and j (step S43). This processing will be explained by using FIG. 10.

The processing unit 120 performs the processing for calculating the intermediate value of the physical quantity q (step S63). This processing is the same as the processing in FIG. 8. As described above, when the intermediate values of the physical quantities q are stored in the data storage unit 130, data may be merely read out from the data storage unit 130 instead of executing this processing.

Then, the processing unit 120 uses the time-space intermediate values of the physical quantity q to calculate the time-space intermediate value vᵢⱼ^{lij,n+1/2} for the velocity according to the equation (27) (step S65). After the calculation of the equation (27), the following calculation is performed.

vᵢⱼ^{l}^{ᵢⱼ}^{,n+1/2}=vᵢⱼ^{n+1/2}·lᵢⱼ

Returning to the explanation of the processing in FIG. 9, the processing unit 120 updates the temporal change term of the density of the particle i according to the following equation (step S45).

$$\frac{d ρ}{d t} {\vert}_{i}^{n} = \frac{d ρ}{d t} {\vert}_{i}^{n} + 2 ( {m}_{j} \frac{{ρ}_{i}^{n}}{{ρ}_{j}^{n}} ( \frac{{v}_{i}^{{l}_{ij} , n} + {v}_{i}^{{l}_{ij} , n + 1}}{2} - {v}_{ij}^{{l}_{ij} , n + \frac{1}{2}} ) \frac{\partial W ( \vert {x}_{ij}^{n + \frac{1}{2}} \vert )}{\partial ( \vert {x}_{ij}^{n + \frac{1}{2}} \vert )} )$$

Then, the processing unit 120 determines whether or not there is an unprocessed particle j among the particles extracted at the step S13 (step S47). When there is an unprocessed particle j, the processing returns to the step S41. On the other hand, when there is no unprocessed particle j, the processing unit 120 updates the density of the particle i from the term of the density of the particle i according to a following equation (step S49).

$${ρ}_{i}^{n + 1} = {ρ}_{i}^{n} + dt \frac{d ρ}{d t} {\vert}_{i}^{n}$$

Furthermore, the processing unit 120 updates the position of the particle i by dt/2 by using the velocity vⁿ⁺¹ᵢ at the time n+1, which was calculated at the step S23 (step S51). The calculation is performed by the following equation.

$${x}_{i}^{n + 1} = {x}_{i}^{n + \frac{1}{2}} + \frac{dt}{2} {v}_{i}^{n + 1}$$

Then, the processing unit 120 determines whether or not there is an unprocessed particle i (step S53). When there is an unprocessed particle i, the processing returns to the step S5 in FIG. 5 through terminal C. On the other hand, when there is no unprocessed particle i, the processing unit 120 stores results for the time n+1 into the processing result storage unit 140, and the output unit 150 outputs the processing results for the time n+1, which are stored in the processing result storage unit 140, to the output apparatus 200 in a predetermined format (step S55).

Then, the processing unit 120 determines whether or not the time n+1 is an end time (step S57). When the time n+1 is not the end time, the processing unit 120 sets n=n+1 (step S59), and sets “unprocessed” to all of the particles i (step S61). Then, the processing returns to the step S5 in FIG. 5 through the terminal C. On the other hand, when the time n+1 is the end time, the processing ends.

By performing the aforementioned processing, the high precision of the calculation by the Riemann solver that is used in the particle method can be realized.

Although the embodiment of this invention was explained above, this invention is not limited to this embodiment. For example, the functional block configuration illustrated in FIG. 4 is a mere example, and does not correspond to the program module configuration and file configuration.

As for the processing flow, as long as the processing results do not change, the turns of the steps may be exchanged or plural steps may be executed in parallel.

Furthermore, the information processing apparatus 100 may not be one computer, but may be made by plural computers. Furthermore, the information processing apparatus 100 may be implemented by a client-server type system or may be implemented by a stand-alone type system.

In addition, the aforementioned information processing apparatus 100 is a computer device as illustrated in FIG. 11. That is, a memory 2501 (storage device), a CPU 2503 (processor), a hard disk drive (HDD) 2505, a display controller 2507 connected to a display device 2509, a drive device 2513 for a removable disk 2511, an input unit 2515, and a communication controller 2517 for connection with a network are connected through a bus 2519 as illustrated in FIG. 11. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform predetermined operations. Moreover, intermediate processing data is stored in the memory 2501, and if necessary, it is stored in the HDD 2505. In this embodiment of this technique, the application program to realize the aforementioned functions is stored in the computer-readable, non-transitory removable disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the application programs systematically cooperate with each other, so that various functions as described above in details are realized.

The aforementioned embodiment is outlined as follows:

A numerical calculation method relating to the embodiment includes: (A) performing a first processing for each second particle of second particles that are identified from a positional relationship with a first particle among a plurality of first particles, wherein the plurality of first particles relate to a first fluid that has a first reference density, and a plurality of second particles relate to a second fluid that has a second reference density, and the first processing comprises: (a1) first calculating a first physical quantity obtained by using, in a Riemann invariant, a ratio of a first density of the first particle to the first reference density, instead of the first density; (a2) second calculating a second physical quantity obtained by using, in the Riemann invariant, a ratio of a second density of the second particle to the second reference density, instead of the second density; (a3) third calculating a gradient of the first physical quantity and a gradient of the second physical quantity; (a4) fourth calculating a time-space intermediate value for the first and second physical quantities between the first particle and the second particle, by using the first physical quantity, the second physical quantity, the gradient of the first physical quantity and the gradient of the second physical quantity; (a5) fifth calculating a time-space intermediate value for pressure between the first particle and the second particle, by using the time-space intermediate value for the first and the second physical quantities; and (a6) sixth calculating a time-space intermediate value for a velocity between the first particle and the second particle, by using the time-space intermediate value for the first and second physical quantities; (B) first updating a velocity of the first particle by using the calculated time-space intermediate value for the pressure; and (C) second updating the first density of the first particle based on the calculated time-space intermediate value for the velocity.

Thus, by transforming the Riemann invariants and defining new physical quantities, the high-precision calculation by the Riemann solver can be realized.

Moreover, the aforementioned third calculating may include: calculating the gradient of the first physical quantity by using a spatial gradient of the first reference density; and calculating the gradient of the second physical quantity by using a spatial gradient of the second reference density. By transforming the Riemann invariant by using the ratio of the density of the particle to the reference density, the gradient of the Riemann invariant is transformed in a form that the spatial gradient of the first reference (or criterion) density is used.

Furthermore, the aforementioned first updating may include: (b1) updating an acceleration of the first particle from the calculated time-space intermediate value for the pressure; and (b2) updating the velocity of the first particle by using the calculated acceleration of the first particle. The acceleration is initially set by an external force such as gravity, however, the influence from the second particle is superimposed to further update the acceleration and velocity.

Moreover, the aforementioned second updating may include: (c1) calculating temporal change of the first density of the first particle by using the velocity of the first particle and the calculated time-space intermediate value for the velocity; and (c2) updating the first density of the first particle by using the temporal change of the first density of the first particle.

For example, after the time-space intermediate value for the pressure for the second particle that is identified from the positional relationship with the first particle is obtained in the first processing and the velocity of the first particle is updated, the temporal change of the first density of the first particle may be calculated. Thus, the accuracy of the calculation is enhanced.

Incidentally, it is possible to create a program causing a computer to execute the aforementioned processing, and such a program is stored in a computer readable storage medium or storage device such as a flexible disk, CD-ROM, DVD-ROM, magneto-optic disk, a semiconductor memory, and hard disk. In addition, the intermediate processing result is temporarily stored in a storage device such as a main memory or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A non-transitory computer-readable storage medium storing a program for directing a computer to execute a process, the process comprising:
performing a first processing for each second particle of second particles that are identified from a positional relationship with a first particle among a plurality of first particles, wherein the plurality of first particles relate to a first fluid that has a first reference density, and a plurality of second particles relate to a second fluid that has a second reference density, and
the first processing comprises:
first calculating a first physical quantity obtained by using, in a Riemann invariant, a ratio of a first density of the first particle to the first reference density, instead of the first density;
second calculating a second physical quantity obtained by using, in the Riemann invariant, a ratio of a second density of the second particle to the second reference density, instead of the second density;
third calculating a gradient of the first physical quantity and a gradient of the second physical quantity;
fourth calculating a time-space intermediate value for the first and second physical quantities between the first particle and the second particle, by using the first physical quantity, the second physical quantity, the gradient of the first physical quantity and the gradient of the second physical quantity;
fifth calculating a time-space intermediate value for pressure between the first particle and the second particle, by using the time-space intermediate value for the first and the second physical quantities; and
sixth calculating a time-space intermediate value for a velocity between the first particle and the second particle, by using the time-space intermediate value for the first and second physical quantities;
first updating a velocity of the first particle by using the calculated time-space intermediate value for the pressure; and
second updating the first density of the first particle based on the calculated time-space intermediate value for the velocity.

2. The non-transitory computer-readable storage medium as set forth in claim 1, wherein the third calculating comprises:
calculating the gradient of the first physical quantity by using a spatial gradient of the first reference density; and
calculating the gradient of the second physical quantity by using a spatial gradient of the second reference density.

3. The non-transitory computer-readable storage medium as set forth in claim 1, wherein the first updating comprises:
updating an acceleration of the first particle from the calculated time-space intermediate value for the pressure; and
updating the velocity of the first particle by using the calculated acceleration of the first particle.

4. The non-transitory computer-readable storage medium as set forth in claim 1, wherein the second updating comprises:
calculating temporal change of the first density of the first particle by using the velocity of the first particle and the calculated time-space intermediate value for the velocity; and
updating the first density of the first particle by using the temporal change of the first density of the first particle.

5. A numerical calculation method, comprising:
performing, by using a computer, a first processing for each second particle of second particles that are identified from a positional relationship with a first particle among a plurality of first particles, wherein the plurality of first particles relate to a first fluid that has a first reference density, and a plurality of second particles relate to a second fluid that has a second reference density, and
the first processing comprises:
first calculating a first physical quantity obtained by using, in a Riemann invariant, a ratio of a first density of the first particle to the first reference density, instead of the first density;
second calculating a second physical quantity obtained by using, in the Riemann invariant, a ratio of a second density of the second particle to the second reference density, instead of the second density;
third calculating a gradient of the first physical quantity and a gradient of the second physical quantity;
fourth calculating a time-space intermediate value for the first and second physical quantities between the first particle and the second particle, by using the first physical quantity, the second physical quantity, the gradient of the first physical quantity and the gradient of the second physical quantity;
fifth calculating a time-space intermediate value for pressure between the first particle and the second particle, by using the time-space intermediate value for the first and the second physical quantities; and
sixth calculating a time-space intermediate value for a velocity between the first particle and the second particle, by using the time-space intermediate value for the first and second physical quantities;
first updating, by using the computer, a velocity of the first particle by using the calculated time-space intermediate value for the pressure; and
second updating, by using the computer, the first density of the first particle based on the calculated time-space intermediate value for the velocity.

6. A numerical calculation apparatus, comprising:
a memory; and
a processor configured to use the memory and execute a process comprising:
performing a first processing for each second particle of second particles that are identified from a positional relationship with a first particle among a plurality of first particles, wherein the plurality of first particles relate to a first fluid that has a first reference density, and a plurality of second particles relate to a second fluid that has a second reference density, and
the first processing comprises:
first calculating a first physical quantity obtained by using, in a Riemann invariant, a ratio of a first density of the first particle to the first reference density, instead of the first density;
second calculating a second physical quantity obtained by using, in the Riemann invariant, a ratio of a second density of the second particle to the second reference density, instead of the second density;
third calculating a gradient of the first physical quantity and a gradient of the second physical quantity;
fourth calculating a time-space intermediate value for the first and second physical quantities between the first particle and the second particle, by using the first physical quantity, the second physical quantity, the gradient of the first physical quantity and the gradient of the second physical quantity;
fifth calculating a time-space intermediate value for pressure between the first particle and the second particle, by using the time-space intermediate value for the first and the second physical quantities; and
sixth calculating a time-space intermediate value for a velocity between the first particle and the second particle, by using the time-space intermediate value for the first and second physical quantities;
first updating a velocity of the first particle by using the calculated time-space intermediate value for the pressure; and
second updating the first density of the first particle based on the calculated time-space intermediate value for the velocity.
